(19) United States
(12) Patent Application Publication
(10) Pub. No.: US 2009/0251415 A1
(43) Pub. Date: Oct. 8, 2009

(54) Optical Pointing Device

(76) Inventors: Tien-Chia LIU, Hsinchu (TW); Hung-Ching LAI, Hsinchu (TW); Hui-Hsuan CHEN, Hsinchu (TW)

Correspondence Address: HDLS Patent & Trademark Services, P.O. BOX 220746, CHANTILLY, VA, 20153-0746, US

(21) Appl. No.: 12/142,749

(22) Filed: Jun. 19, 2008

(30) Foreign Application Priority Data
Apr. 3, 2008 (TW) 097112324

(51) Int. Cl. G06F 3/033; G02B 5/18

(52) U.S. Cl. 345/166; 359/571

(57) ABSTRACT

An optical pointing device includes an illumination system, an imaging system and at least one diffraction element. The illumination system includes a light source for providing a light beam to a reflective surface outside the optical pointing device. The imaging system includes an image sensor disposed on a transmission path of the light beam after being reflected by the reflective surface. The at least one diffraction element is disposed in the illumination system and/or the imaging system and disposed on the transmission path of the light beam to change the transmission path of the light beam. The present optical pointing device can achieve the advantage of small volume.

### BACKGROUND

1. Technical Field

The present invention generally relates to a pointing device and, more particularly, to an optical pointing device.

2. Description of the Related Art

An optical mouse is a type of commonly used pointing device for moving a cursor displayed on a computer screen. Generally, the optical mouse is put on a reflective surface. A light beam provided by a light source of the optical mouse is reflected to an image sensor of the optical mouse by the reflective surface, therefore when the optical mouse is moved, the cursor displayed on the screen would correspondingly move on the screen.

FIG. 1 is a schematic view of a conventional optical mouse. As illustrated in FIG. 1, the conventional optical mouse 100 includes an illumination system 110 and an imaging system 120. The illumination system 110 includes a laser diode (LD) 112 and a refraction element 114. The laser diode 112 is for providing a light beam 113. The refraction element 114 is disposed on a transmission path of the light beam 113 to refract the light beam 113 to a reflective surface 50 outside the optical mouse 100. In addition, the imaging system 120 includes an image sensor 122 and a focusing lens 124. The image sensor 122 is disposed on a transmission path of the light beam 113 after being reflected by the reflective surface 50. The focusing lens 124 is disposed before the image sensor 122 to focus the light beam 113 on the image sensor 122.

In the prior art, in order to facilitate the assembly of the optical mouse 100, the refraction element 114 and the focusing lens 124 are integrated into a transparent body 130. However, since the refraction element 114 has a particular tilt angle, which results in the manufacture for the transparent body 130 is difficult and the thickness D1 of the transparent body 130 could not be further reduced.

### BRIEF SUMMARY

The present invention provides an optical pointing device having the advantage of small volume.

In order to achieve the above-mentioned advantage, an optical pointing device in accordance with an embodiment of the present invention is provided. The optical pointing device includes an illumination system, an imaging system and at least one diffraction element. The illumination system includes a light source for providing a light beam to a reflective surface outside the optical pointing device. The imaging system includes an image sensor disposed on a transmission path of the light beam after being reflected by the reflective surface. The at least one diffraction element is arranged in the illumination system and/or the imaging system and disposed on the transmission path of the light beam to change the transmission path of the light beam.

In one embodiment of the present invention, the at least one diffraction element includes a Fresnel lens.

In one embodiment of the present invention, the at least one diffraction element includes a diffraction grating.

In one embodiment of the present invention, the at least one diffraction element each is a phase grating or an amplitude grating.

In one embodiment of the present invention, the phase grating is a blazed grating.

In one embodiment of the present invention, the illumination system further includes a focusing element disposed on the transmission path of the light beam. Furthermore, the at least one diffraction element for example is integrated with a focusing surface of the focusing element.

In one embodiment of the present invention, the imaging system further includes a focusing element disposed before the image sensor and on the transmission path of the light beam. Furthermore, the at least one diffraction element for example is integrated with a focusing surface of the focusing element.

In one embodiment of the present invention, the number of the at least one diffraction element of the optical pointing device is two. One of the diffraction elements is arranged in the illumination system and the other diffraction element is arranged in the imaging system.

In one embodiment of the present invention, the optical pointing device further includes a transparent body, and the at least one diffraction element is integrated into the transparent body.

In one embodiment of the present invention, the optical pointing device further comprises a circuit board, wherein the light source and the image sensor are arranged on the circuit board, and the transparent body is connected to the circuit board.

In one embodiment of the present invention, the light source is a laser diode or a light emitting diode (LED).

In one embodiment of the present invention, the light beam provided by the light source is an infrared light.

The present invention utilizes the at least one diffraction element to change the transmission path of the light beam in the illumination system and/or the imaging system. Since the transparent body has the at least one diffraction element integrated therein, which renders the transparent body can achieve the advantages of easily being manufactured and thin in thickness. Accordingly, the optical pointing device in accordance with the present invention can achieve the advantages of small volume and easily being manufactured.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a conventional optical mouse.

FIG. 2 is a schematic view of an optical pointing device in accordance with an embodiment of the present invention.

FIG. 3 through FIG. 6 respectively are schematic views of optical pointing devices in accordance with other four embodiments of the present invention.

FIG. 7 is a schematic view of an optical pointing device in accordance with another embodiment of the present invention.

FIG. 8 is a schematic view of an optical pointing device in accordance with still another embodiment of the present invention.

FIG. 9 is a schematic view of an optical pointing device in accordance with further still another embodiment of the present invention.

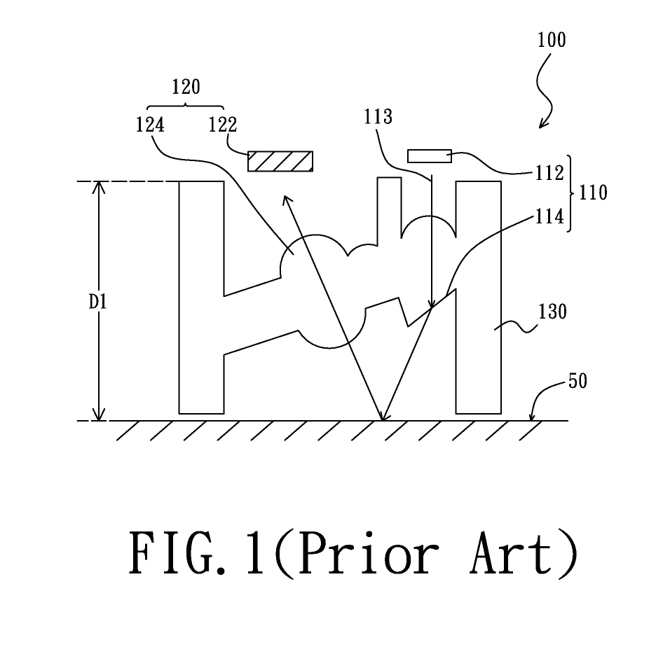

### DETAILED DESCRIPTION

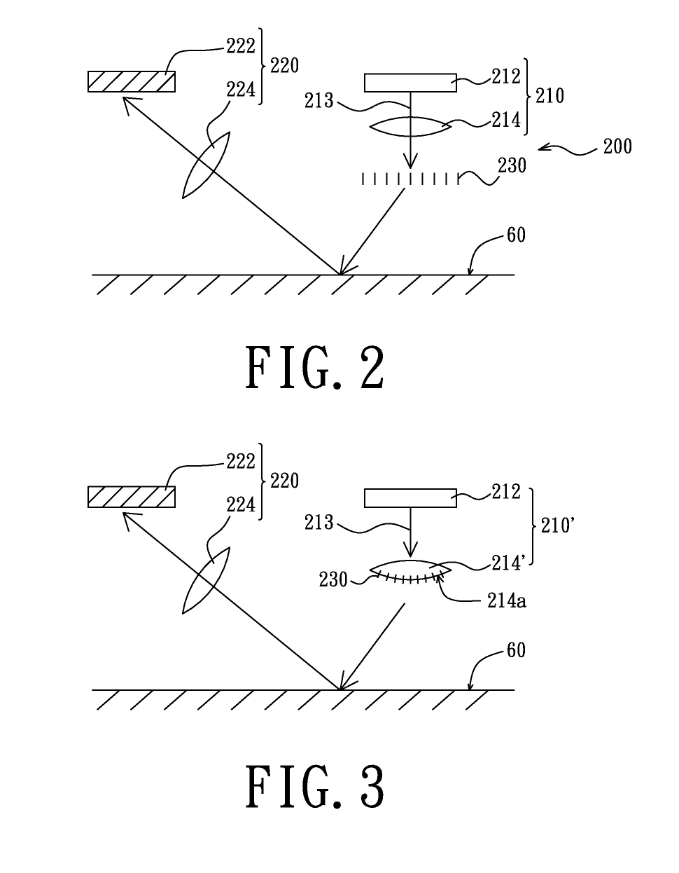

FIG. 2 is a schematic view of an optical pointing device in accordance with an embodiment of the present invention. As illustrated in FIG. 2, the optical pointing device 200 can be but not limited to an optical mouse. The optical pointing device 200 includes an illumination system 210, an imaging system 220 and a diffraction element 230. The illumination system 210 includes a light source 212 for providing a light beam 213 to a reflective surface 60 outside the optical pointing device 200. The imaging system 220 includes an image sensor 222 disposed on a transmission path of the light beam 213 after being reflected by the reflective surface 60. The diffraction element 230 is arranged in the illumination system 210 and disposed on the transmission path of the light beam 213 to change the transmission path of the light beam 213. More specifically, the diffraction element 230 can be a Fresnel lens or a diffraction grating. The diffraction grating can be a phase grating or an amplitude grating. The phase grating can be a blazed grating. The diffraction element 230 is for adjusting an incident angle of the light beam 213 striking the reflective surface 60. Furthermore, regarding the principle of how the diffraction element 230 to change the transmission path of the light beam 213 is well-known in the art, and thus will not be described in detail herein.

In the optical pointing device 200, the light source 212 can be a laser diode or a light emitting diode. The light beam 213 of the light source 212 for example is a monochromatic light or an invisible light (e.g., infrared light). The image sensor 222 for example is a complementary metal oxide semiconductor (CMOS) image sensor or a charge coupled device (CCD). Furthermore, the illumination system 210 can further include a focusing element 214. The focusing element 214 is disposed on the transmission path of the light beam 213 to focus the light beam 213 on the reflective surface 60. In addition, the imaging system 220 can further include a focusing element 224. The focusing element 224 is disposed before the image sensor 222 and on the transmission path of the light beam 213 to focus the light beam 213 on the image sensor 222.

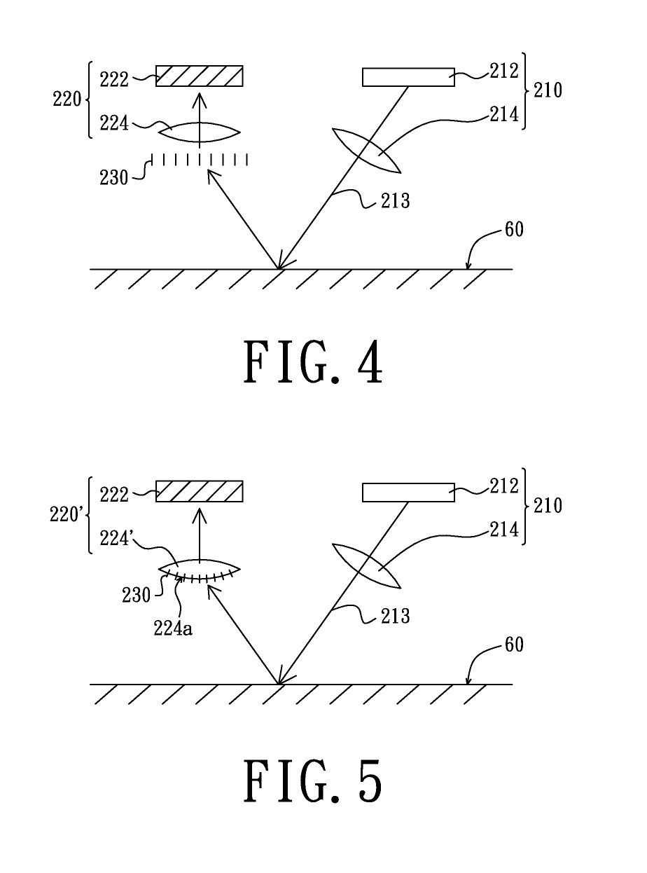

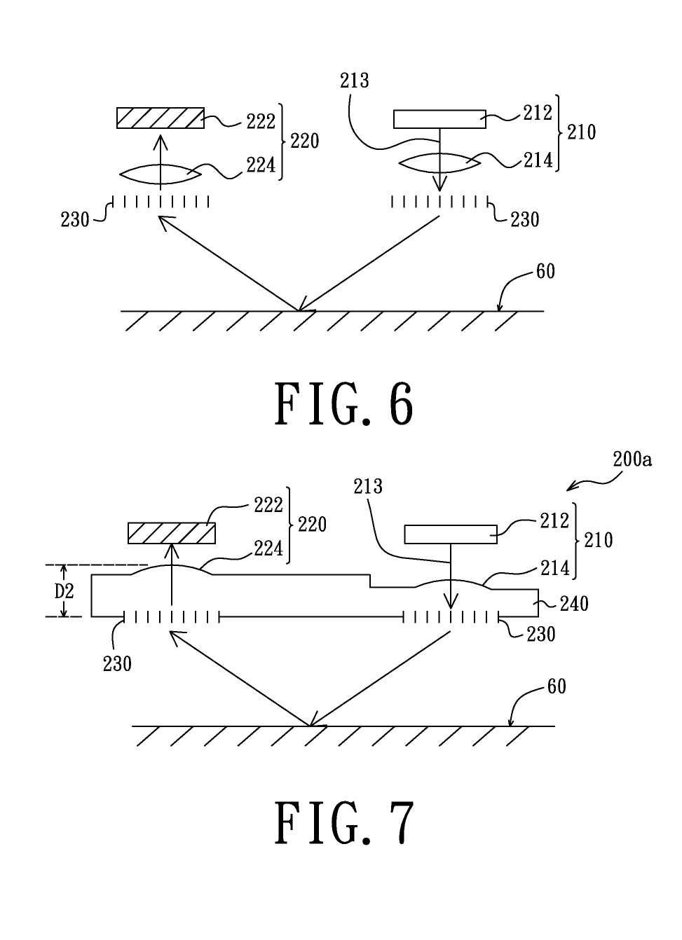

FIG. 3 through FIG. 6 respectively are schematic views of optical pointing devices in accordance with other four embodiments. Referring to FIG. 3 firstly, in the illustrated embodiment of the diffraction element 230 being a diffraction grating, the diffraction grating 230 can be integrated with a focusing surface 214a of a focusing element 214′ of the illumination system 210′. In addition, referring to FIG. 4, in another embodiment of the present invention, the diffraction element 230 can be arranged in the imaging system 220 to adjust an incident angle of the light beam 213 striking on the image sensor 222. Referring to FIG. 5, in the illustrated embodiment of the diffraction element 230 being a diffraction grating, the diffraction element 230 can be integrated with a focusing surface 224a of a focusing element 224′ of the imaging system 220′. Referring to FIG. 6, in another embodiment of the present invention, the number of the diffraction element 230 can be two, and the two diffraction elements 230 are respectively arranged in the illumination system 210 and the imaging system 220. In addition, the diffraction elements 230 can respectively be integrated with the focusing surfaces of the focusing elements 214, 224.

In order to facilitate the assembly, the focusing element 214 or 214′, focusing element 224 or 224′ and diffraction element 230 in accordance with the above-mentioned embodiments can be integrated into a transparent body. Regarding embodiments of the focusing element 214 or 214′, focusing element 224 or 224′ and diffraction element 230 being integrated into a transparent body will be described below in detail accompanying corresponding drawings.

FIG. 7 is a schematic view of an optical pointing device in accordance with one embodiment of the present invention. As illustrated in FIG. 7, compared with FIG. 6, the optical pointing device 200a in the present embodiment further includes a transparent body 240, and the diffraction element 230 and the focusing elements 214, 224 are integrated with the transparent body 240. In other words, the diffraction element 230 and the focusing elements 214, 224 can be manufactured by injection molding and thus the diffraction element 230 and the focusing elements 214, 224 can be integrated into one single piece.

In the present embodiment, the manufacture for the transparent body 240 having the diffraction element 230 and the focusing elements 214, 224 integrated therein is relatively simple. Furthermore, since the diffraction element 230 is arranged without need a particular tilt angle, a thickness D2 of the transparent body 240 can be considerably reduced. Accordingly, the optical pointing device 200a has a small volume. Furthermore, the diffraction element 230 can achieve good effect for noise suppression. In addition, the diffraction element 230 can facilitate the light beam 213 to perpendicularly incident on the focusing element 224, so that the image quality can be easily controlled.

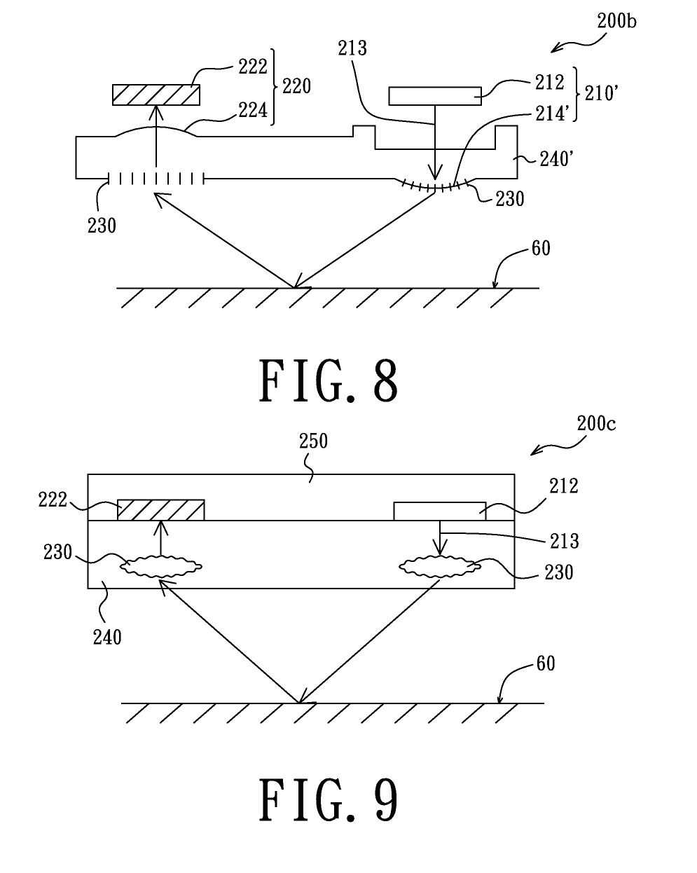

FIG. 8 is a schematic view of an optical pointing device in accordance with one embodiment of the present invention. As illustrated in FIG. 8, the optical pointing device 200b in accordance with the present embodiment is similar to that in FIG. 7, the difference is that a transparent body 240′ of the optical pointing device 200b is integrated with the diffraction element 230 and the focusing elements 214′ 224 together. Furthermore, the diffraction element 230 arranged in the illumination system 210′ is integrated with the focusing element 214′ of the illumination system 210′.

FIG. 9 is a schematic view of an optical pointing device in accordance with one embodiment of the present invention. An optical pointing device 200c in the present embodiment further includes a circuit board 250, and the light source 212 and image sensor 222 are arranged on the circuit board 250. The diffraction element 230 is integrated into the transparent body 240, and the transparent body 240 is connected to the circuit board 250. Since during the assembly of the optical pointing device 200c, it only needs to connect the transparent body 240 with the circuit board 250 together, therefore the present optical pointing device 200c can achieve the advantage of easily being assembled.

In summary, the optical pointing device in accordance with the present invention at least can achieve the following advantages: (1) the present optical pointing device utilizes the diffraction element(s) to change the transmission path of the light beam in the illumination system and/or the imaging system, and the diffraction element(s) can achieve good effect of noise suppression. (2) By integrating the diffraction element(s) into the transparent body, the transparent body consequently has the advantages of small volume and easily being manufactured.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An optical pointing device, comprising:
an illumination system comprising a light source for providing a light beam to a reflective surface outside the optical pointing device;
an imaging system comprising an image sensor disposed on a transmission path of the light beam after being reflected by the reflective surface; and
at least one diffraction element arranged in the illumination system and/or the imaging system and disposed on the transmission path of the light beam to change the transmission path of the light beam.

2. The optical pointing device as claimed in claim 1, wherein the at least one diffraction element comprises a Fresnel lens.

3. The optical pointing device as claimed in claim 1, wherein the at least one diffraction element comprises a diffraction grating.

4. The optical pointing device as claimed in claim 3, wherein the diffraction grating is one of a phase grating and an amplitude grating.

5. The optical pointing device as claimed in claim 4, wherein the phase grating is a blazed grating.

6. The optical pointing device as claimed in claim 3, wherein the illumination system further comprises a focusing element disposed on the transmission path of the light beam.

7. The optical pointing device as claimed in claim 6, wherein the at least one diffraction grating is integrated with a focusing surface of the focusing element.

8. The optical pointing device as claimed in claim 3, wherein the imaging system further comprises a focusing element disposed before the image sensor and on the transmission path of the light beam.

9. The optical pointing device as claimed in claim 8, wherein the diffraction element is integrated with a focusing surface of the focusing element.

10. The optical pointing device as claimed in claim 1, wherein the number of the at least one diffraction element is two, one of the diffraction elements is arranged in the illumination system and the other diffraction element is arranged in the imaging system.

11. The optical pointing device as claimed in claim 10, further comprising a transparent body, the diffraction elements being integrated with the transparent body.

12. The optical pointing device as claimed in claim 11, further comprising a circuit board, the light source and the image sensor being disposed on the circuit board and the transparent body being connected to the circuit board.

13. The optical pointing device as claimed in claim 1, wherein the light source comprises one of a laser diode and a light emitting diode.

14. The optical pointing device as claimed in claim 1, wherein the light beam provided by the light source is an infrared light.
